(19) United States
(12) Patent Application Publication
(10) Pub. No.: US 2009/0095638 A1
(43) Pub. Date: Apr. 16, 2009

(54) SOIL AND GROUNDWATER REMEDIATION SYSTEM AND METHOD

(75) Inventors: Thomas Skoczylas, Guilford, CT (US); A. John Speranza, West Hartford, CT (US)

Correspondence Address: CANTOR COLBURN, LLP - PROTON, 20 Church Street, 22nd Floor, Hartford, CT, 06103, US

(73) Assignee: PROTON ENERGY SYSTEMS, INC., Wallingford, CT (US)

(21) Appl. No.: 11/869,943

(22) Filed: Oct. 10, 2007

(51) Int. Cl. C02F 1/469

(52) U.S. Cl. 205/742; 204/276; 204/275.1

(57) ABSTRACT

A system and process for remediation of a contaminated environment such as soil and groundwater is disclosed. The system includes a hydrogen generation device that produces hydrogen gas, oxygen gas and a hydrogen-water mixture. The hydrogen-water mixture is injected under pressure into the contaminated environment to stimulate anaerobic decomposition of the contaminating materials such as halogenated hydrocarbons. The oxygen gas is also injected into portions of the contaminated environment containing non-chlorinated hydrocarbons to promote aerobic decomposition.

### BACKGROUND OF THE INVENTION

The subject matter disclosed herein relates to a system and method for remediation of a contaminated environment, such as soil and groundwater, using an electrolytic cell, and more particularly to a system and method of remediation utilizing oxygen gas and hydrogenated water.

Soil and groundwater contamination may come from many sources. Due to the desire to preserve public safety, water supplies and resources, government agencies have established maximum contamination levels for many chemical compounds. If the contamination level has been exceeded, the operator of the site may be responsible for the costs associated with the remediation of the contaminated soil or ground water. In the past, remediation involved excavation of the soil which was then either treated, through incineration for example, or otherwise disposed. Where the contamination was over a large area, or where the contamination ran deeply into the soil, the cost of excavation could be extremely high.

In an effort to provide remediation onsite without resorting to excavation, certain biological treatments have been utilized to foster decomposition of the contaminants. These treatments involved the injection of a gas, typically either hydrogen or oxygen into bore holes drilled in the contaminated areas. The injected gases promoted growth of various bacteria that would mineralize certain types of chemicals such as halogenated hydrocarbons and non-chlorinated hydrocarbons.

While remediation methods are suitable for their intended purposes, there still remains a need for improvements regarding the efficient operation of remediation systems and in particular at sites requiring the remediation of both halogenated hydrocarbons and non-chlorinated hydrocarbons.

### SUMMARY OF THE INVENTION

A system for remediation of soil and groundwater is provided that includes an electrochemical cell having an anode chamber and a cathode chamber. A hydrogen phase separator is fluidly coupled to the cathode chamber and the hydrogen phase separator has a gaseous portion and a liquid portion. A conduit has a first and second end where the first end is coupled to the hydrogen phase separator liquid portion and the second end is extended into a contaminated environment.

A system for remediation of soil and ground water is also provided that includes an electrochemical cell having an anode chamber and a cathode chamber. A conduit having a first and second end is coupled to the electrochemical cell. The conduit has a first end directly coupled to electrochemical cathode chamber and the conduit has a second end that extends into a contaminated environment. A pressure control device is coupled to the conduit.

A method for anaerobic and aerobic remediation of contaminated soil and groundwater is also provided. The method includes the steps of electrolyzing water to form an oxygen water mixture and a mixture including suspended hydrogen gas and hydrogen gas dissolved in water. The suspended hydrogen gas is separated from the water and dissolved hydrogen. The oxygen gas is separated from the oxygen water mixture. The dissolved hydrogen is injected into a contaminated soil or groundwater and the oxygen gas is into contaminated soil or groundwater.

A method of contaminated soil and groundwater remediation is also provided that includes the following steps. First, water is electrolyzed in an electrochemical cell. An oxygen water mixture and a hydrogen water mixture is formed in the electrochemical cell. The hydrogen water mixture is extracted from the electrochemical cell and a portion of the hydrogen gas is separated from the hydrogen water mixture. The remaining hydrogen water mixture is injected into a contaminated environment.

### BRIEF DESCRIPTION OF THE DRAWINGS

Referring now to the drawings, which are meant to be exemplary and not limiting, and wherein like elements are numbered alike:

FIG. 1 is a schematic diagram of a partial prior art electrochemical cell showing an electrochemical reaction;

FIG. 2 is a perspective view of a site having contaminated soil and groundwater;

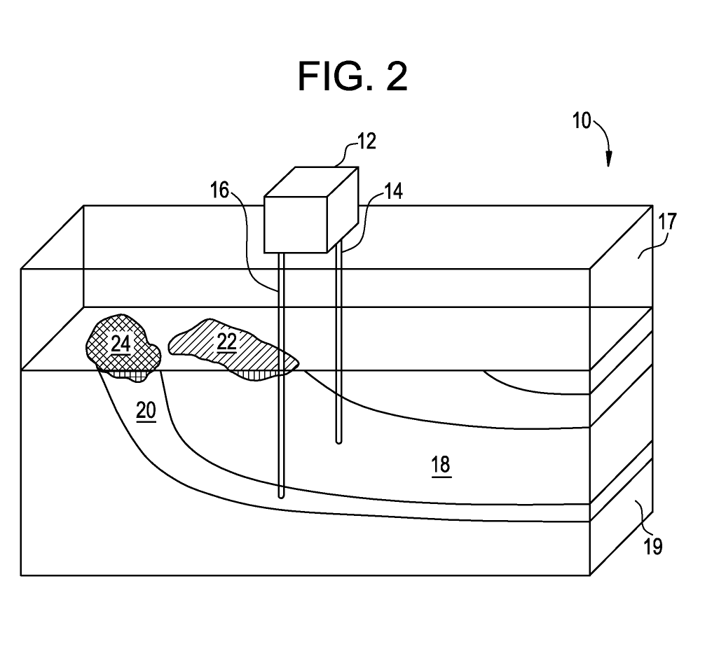

FIG. 3 is a schematic view of an electrochemical remediation system of the exemplary embodiment;

FIG. 4 is an alternate embodiment schematic view of an electrochemical remediation system.

### DETAILED DESCRIPTION

Biological remediation of contaminated soils and groundwater requires the introduction of external stimulants such as oxygen gas or hydrogen gas to facilitate the growth of appropriate bacteria. The type of stimulant used will depend on the type of contaminant that requires remediation. Some contaminants, such as halogenated hydrocarbons, trichloroethene and other chlorinated solvents for example, respond to anaerobic decomposition by bacteria that utilize hydrogen gas. Other contaminants, such as non-chlorinated hydrocarbon or petrochemical fuels for example, respond well to bacteria that need oxygen to promote growth.

A typical contamination site 10, such as an industrial site for example, may require multiple stimulants to decompose both the chlorinated and non-chlorinated hydrocarbon contaminants. In this exemplary illustration, the soil 17 and groundwater 19 become contaminated by halogenated hydrocarbon source 22 and non-chlorinated hydrocarbon 24. These sources 22, 24 may be result from several sources such as a leaking holding tank or a surface spill for example. Uncontaminated ground water may exist at a point outside the impact area of plume 20 creating an aerobic margin along the perimeter of plume 20. Mixing and natural bioremediation may occur in this aerobic margin through an oxygen exchange with uncontaminated groundwater. These sources contaminate the groundwater 19 via plumes 18, 20. In the exemplary embodiment, an electrochemical system 12 is provided that is capable of producing both oxygen and hydrogen that is injected into the respective plumes via conduits 14 and 16.

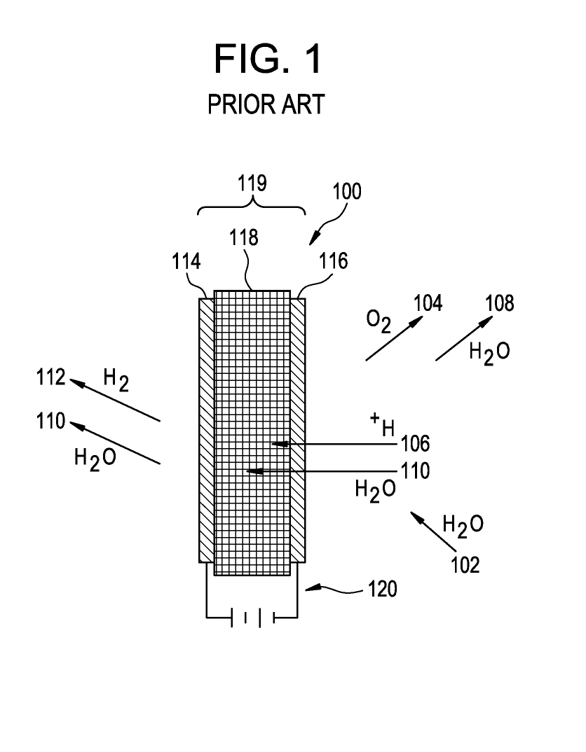

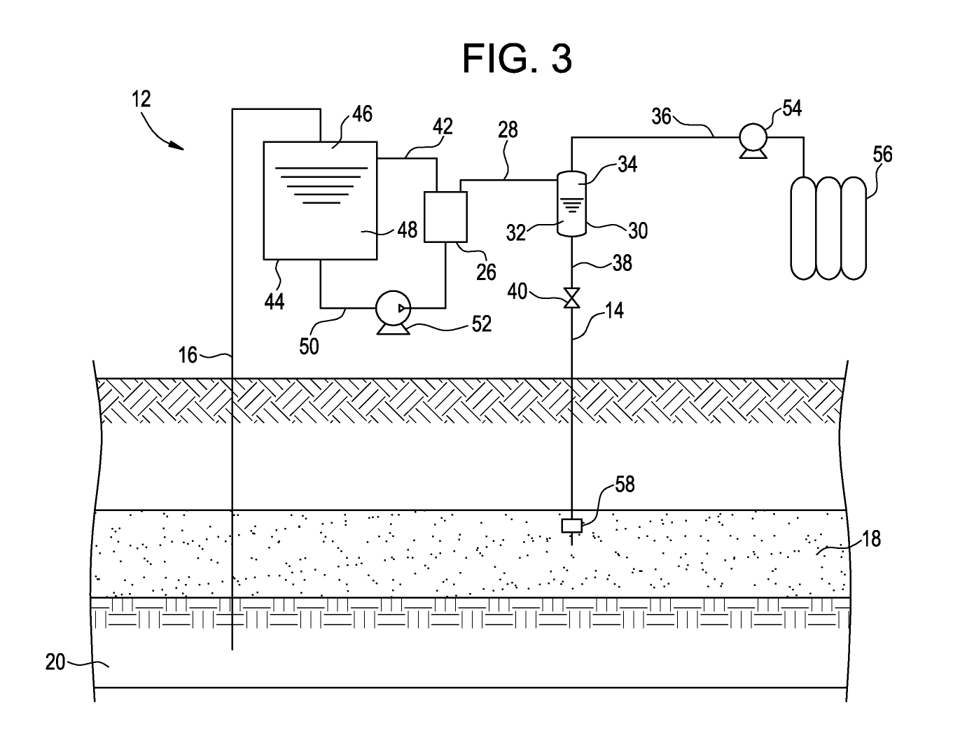

Referring to FIG. 3, an exemplary decontamination system 12 is shown. Electrochemical cells 26 typically include one or more individual cells arranged in a stack, with the working fluids directed through the cells via input and output conduits formed within the stack structure. The cells within the stack are sequentially arranged, each including a cathode, a proton exchange membrane, and an anode (hereinafter “membrane electrode assembly”, or “MEA” 119) as shown in FIG. 1. Each cell typically further comprises a first flow field in fluid communication with the cathode and a second flow field in fluid communication with the anode. The MEA 119 may be supported on either or both sides by screen packs or bipolar plates disposed within the flow fields, and which may be configured to facilitate membrane hydration and/or fluid movement to and from the MEA 119.

Membrane 118 comprises electrolytes that are preferably solids or gels under the operating conditions of the electrochemical cell. Useful materials include, for example, proton conducting ionomers and ion exchange resins. Useful proton conducting ionomers include complexes comprising an alkali metal salt, alkali earth metal salt, a protonic acid, a protonic acid salt or mixtures comprising one or more of the foregoing complexes. Counter-ions useful in the above salts include halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt can be complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene)glycol, poly(oxyethylene-co-oxypropylene)glycol monoether, and poly(oxyethylene-co-oxypropylene)glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid exhibit sufficient ionic conductivity to be useful.

Ion-exchange resins useful as proton conducting materials include hydrocarbon-and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that can be imbued with cation-exchange ability by sulfonation, or can be imbued with anion-exchange ability by chloromethylation followed by conversion to the corresponding quaternary amine.

Fluorocarbon-type ion-exchange resins can include, for example, hydrates of tetrafluoroethylene-perfluorosulfonyl ethoxyvinyl ether or tetrafluoroethylene-hydroxylated(perfluoro vinyl ether)copolymers and the like. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids, and bases. One family of fluorocarbon-type resins having sulfonic acid group functionality is NAFION™ resins (commercially available from E. I. du Pont de Nemours and Company, Wilmington, Del.).

Electrodes 114 and 116 comprise catalysts suitable for performing the needed electrochemical reaction (i.e., electrolyzing water to produce hydrogen and oxygen). Suitable electrodes comprise, but are not limited to, platinum, palladium, rhodium, carbon, gold, tantalum, tungsten, ruthenium, iridium, osmium, and the like, as well as alloys and combinations comprising one or more of the foregoing materials. Electrodes 114 and 116 can be formed on membrane 118, or may be layered adjacent to, but in contact with or in ionic communication with, membrane 118.

Flow field members (not shown) and support membrane 118, allow the passage system fluids, and preferably are electrically conductive, and may be, for example, screen packs or bipolar plates. The screen packs include one or more layers of perforated sheets or a woven mesh formed from metal or strands. These screens typically comprise metals, for example, niobium, zirconium, tantalum, titanium, carbon steel, stainless steel, nickel, cobalt, and the like, as well as alloys and combinations comprising one or more of the foregoing metals. Bipolar plates are commonly porous structures comprising fibrous carbon or fibrous carbon impregnated with polytetrafluoroethylene or PTFE (commercially available under the trade name TEFLON® from E. I. du Pont de Nemours and Company).

Alternatively, the hydrogen conversion device 12 may be a biomass reactor that uses chemical and/or electrochemical reactions in the production of hydrogen gas. These processes include naturally occurring organic matter with a base. Preferably, the organic matter is biomass. Biomass is a general term used to refer to all non-fossil organic materials that have intrinsic chemical energy content. Biomass includes organic plant matter, vegetation, trees, grasses, aquatic plants, wood, fibers, animal wastes, municipal wastes, crops and any matter containing photosynthetically fixed carbon. Biomass is available on a renewable or recurring basis and is thus much more readily replenished than fossil fuels. The volume of biomass available makes it a naturally occurring carbon resource that is sufficiently plentiful to substitute for fossil fuels.

The capture of solar energy through photosynthesis drives the formation of biomass. During photosynthesis, the organic compounds that make up biomass are produced from CO2 and H2O in the presence of light. The principle compounds present in biomass are carbohydrates. Glucose (C2H12O6) is a representative carbohydrate found in biomass and is formed in photosynthesis through the reaction:

6CO2+6H2O→C6H12O6+6O2

Reactions of organic substances with a base permit the production of hydrogen gas through the formation of carbonate ion and/or bicarbonate by-products. Inclusion of a base as a reactant in the production of hydrogen from organic substances thus provides a reaction pathway for the production of hydrogen. For example, hydrogen may be produced from glucose (C6H12O6) through exposure to high temperatures in the following reaction:

C6H12O6+6H2O→6CO2+12H2

This reaction is representative of reformation reactions of organic substances that are analogous to those used in the reformation of simple compounds such as methanol or ethanol. In another example, hydrogen may be produced from sucrose by reacting it with a base such as sodium hydroxide (NaOH). Representative reactions of sucrose with sodium hydroxide are given below:

C12H22O11+24NaOH+H2O→12Na2CO3+24H2

or

C12H22O11+12NaOH+13H2O→12NaHCO3+24H2

Alternatively, the hydrogen conversion device may disassociate hydrogen from water through a process known as photolysis. In general, photolysis refers to any chemical reaction through which water is disassociated by light. Typically, the disassociation of water is achieved by subjecting the water to ultraviolet (UV) light in the presence of a catalyst such as titanium dioxide, or tantalum oxide with a co-catalyst nickel oxide. The resultant reaction creates both hydrogen and oxygen gas.

Photolysis may also be utilized with algae through the process of photosynthesis to produce hydrogen gas. Typically, the plant utilizes light from the sun and carbon-dioxide from the air to grow new cells. Through modifications in the algae's environment, the algae may be induced to produce hydrogen rather than oxygen. This process, which typically occurs in a bioreactor, the algae are grown and deprived carbon dioxide and oxygen. This deprivation causes a stress on the algae resulting in a dormant gene becoming activated that results in the synthesis of an enzyme called hydrogenase. The algae use this enzyme to produce both hydrogen and oxygen gas from the surrounding water. Creating a sulfur deficient environment may enhance the process as well.

Referring to FIG. 3, an exemplary embodiment decontamination apparatus 12 will be described. The electrochemical cell stack 26 disassociates water into hydrogen gas and oxygen gas. Since some water migrates across the membrane 118 during the electrolysis process, the hydrogen gas, entrained with water containing dissolved hydrogen exits the cell stack 26 via conduit 28 and enters hydrogen phase separator 30. The hydrogen gas mixture 28 enters the phase separator and experiences a slight pressure drop. This pressure drop results in the separation of the entrained hydrogen gas from the water. In the vertically oriented phase separator 30 of the exemplary embodiment, the water-dissolved hydrogen mixture drops into a liquid portion 32 of the phase separator 30 while the hydrogen gas passes to the upper gaseous portion 34 before exiting the phase separator 30 via conduit 36. The hydrogen gas may be further compressed by a compressor 54 and stored in vessels 56. In the exemplary embodiment, the hydrogen gas is compressed to between 1000 psi-10000 psi, and preferably to 2000 psi.

The stored hydrogen gas may be transported and used for other purposes or may be used locally with other remediation techniques, such as sparging or in-situ diffusion for example. In a sparging process, the hydrogen is forced into a wellbore under sufficient pressure to form branching channels in the groundwater. The hydrogen saturates the groundwater in the contaminated environment to stimulate biodegradation.

The water in phase separator 30, which contains 1-10% hydrogen, and preferably at least 5%, dissolved hydrogen by volume is stored in the liquid portion 32 of the phase separator 30. Periodically, the water mixture is removed via conduit 38. The flow of water is controlled by valve 40 that allows the water mixture to pass into conduit 14. Pressure control device 58 is connected to conduit 14 and maintains the hydrogenated water at sufficient pressure as to keep the hydrogen in solution concentration as high as possible prior to injection into the contaminated soil 18. Preferably, the pressure control device 58 is coupled to the conduit 14 close to the point of injection into the contaminated environment. In the exemplary embodiment, the pressure control device is a pressure regulator that may either be of a fixed type, or be adjustable by the system operator. The cell stack 26 produces hydrogen gas at elevated pressures, preferably between 100 psi and 10,000 psi, and more preferably between 200 psi-2000 psi, and more preferably 200 psi. Since the hydrogen gas enters the phase separator 30 at this pressure, no additional pumping or other assistance is required to transfer the hydrogen-water mixture through conduit 14 into the contaminated soil 18.

A mixture of oxygen gas and water leaves the cell stack 26 via conduit 42. Conduit 42 ends in oxygen phase separator 44. Similar to the hydrogen phase separator 30, the oxygen phase separator includes a liquid portion 48 and a gaseous portion 46. The oxygen-water mixture experiences a pressure drop upon entering the phase separator 44 causing the water to separate and drop to the bottom of the phase separator. The oxygen gas is removed via conduit 16 and injected into the plume 20. The water in the liquid portion 48 of the oxygen phase separator 44 is stored and then transferred via conduit 50 through pump 52 back into cell stack 26.

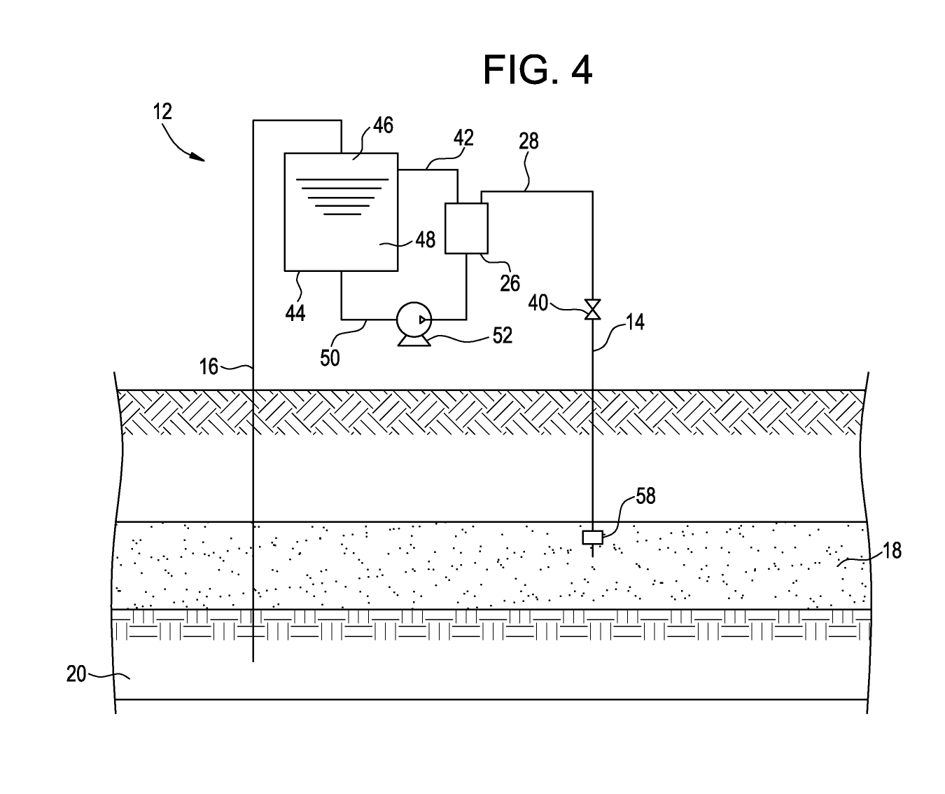

An alternate embodiment decontamination apparatus is illustrated in FIG. 4. In this embodiment, the phase separator 30 is removed from the system. This allows the hydrogen water mixture in conduit 28 to connect directly to conduit 14 via valve 40. The hydrogen water mixture may then be injected, under pressure directly into the contaminated plume 18. The pressure the hydrogen water mixture is injected is preferably between 100 psi and 10,000 psi, and more preferably between 200 psi-2000 psi, and more preferably 200 psi. Similar to the embodiment discussed above, the hydrogen gas is maintained in solution by a pressure control device 58, such as a pressure regulator for example, that is preferably located close to the point of injection into the contaminated environment. The mixture of oxygen gas and water leaves the cell stack 26 via conduit 42. Conduit 42 ends in oxygen phase separator 44. As discussed above, the pressure drop resulting from the transfer of the oxygen water phase separator 44 causes the water and an entrained oxygen gas to separate in the separator 44. The oxygen gas is removed via conduit 16 and injected into the plume 20. The water in the liquid portion 48 of the oxygen phase separator 44 is stored and then transferred via conduit 50 through pump 52 back into cell stack 26.

To perform the remediation, the operator installs the decontamination device 12 near the location of the soil requiring treatment. Boreholes are drilled into the soil to the desired depth to reach each of the plumes 18, 20. In alternate embodiments, multiple boreholes are drilled for the hydrogen-water mixture and the oxygen gas streams to facilitate the remediation of a wider area. The decontamination device 12 is operated generating hydrogen gas, a hydrogen-water mixture, and oxygen gas. The hydrogen-water mixture is periodically injected into the contaminated area. The timing of the injections may depend on a number of factors, including subsurface conditions, hydrogen levels in the contaminated region, and anaerobic bacteria growth rates for example. Alternatively, the valve 40 may be set to continuously inject the hydrogen-water mixture. The hydrogen gas is stored in vessel 56 to be used with alternative remediation techniques or to be sold as an industrial gas. The oxygen gas is injected to stimulate growth or aerobic bacteria that decompose the non-chlorinated hydrocarbon contaminants.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for remediation of soil and groundwater comprising:
an electrochemical cell having an anode chamber and a cathode chamber;
a hydrogen phase separator fluidly coupled to said cathode chamber, said hydrogen phase separator having a gaseous portion and a liquid portion; and,
a first conduit having a first and second end, said first conduit first end coupled to said hydrogen phase separator liquid portion and said first conduit second end extending into a contaminated environment.

2. The system for remediation of soil and groundwater of claim 1 further comprising a second conduit coupled to said hydrogen phase separator gaseous portion.

3. The system for remediation of soil and groundwater of claim 2 further comprising an oxygen phase separator fluidly coupled to said anode chamber, said oxygen phase separator having a gaseous portion and a liquid portion.

4. The system for remediation of soil and groundwater of claim 3 further comprising a third conduit fluidly coupled to said oxygen phase separator gaseous portion.

5. The system for remediation of soil and ground water of claim 4 further comprising a fourth conduit fluidly coupled between said oxygen phase separator liquid portion and said electrochemical cell anode chamber.

6. The system for remediation of soil and ground water of claim 1 further comprising a pressure control device coupled to said first conduit.

7. A system for remediation of soil and ground water comprising:
an electrochemical cell having an anode chamber and a cathode chamber;
a conduit having a first and second end, said conduit first end is directly coupled to said electrochemical cathode chamber and said conduit second end extending into a contaminated environment; and,
a pressure control device coupled to said first conduit.

8. The system for remediation of soil and ground water of claim 8 further comprising a pressure control device coupled to said conduit.

9. The system for remediation of soil and ground water of claim 9 wherein said pressure control device maintains the pressure of a water hydrogen mixture at a pressure between 100 psi and 10,000 psi.

10. The system for remediation of soil and ground water of claim 10 wherein said pressure control device maintain the pressure of said water hydrogen mixture at a pressure of 200 psi.

11. A method for anaerobic and aerobic remediation of contaminated soil and groundwater comprising the steps of:
electrolyzing water to form an oxygen water mixture and a mixture including suspended hydrogen gas and hydrogen gas dissolved in water;
separating suspended hydrogen gas from said water and dissolved hydrogen;
separating oxygen gas from said oxygen water mixture;
injecting said dissolved hydrogen into a contaminated soil or groundwater; and,
injecting said oxygen gas into contaminated soil or groundwater.

12. The method for anaerobic and aerobic remediation of contaminated soil and groundwater of claim 11 wherein said dissolved hydrogen is injected at a pressure greater than 100 psi.

13. The method for anaerobic and aerobic remediation of contaminated soil and groundwater of claim 12 further comprising the step of compressing said hydrogen gas to a pressure between 200 psi-10000 psi.

14. The method for anaerobic and aerobic remediation of contaminated soil and groundwater of claim 12 wherein said dissolved hydrogen is 5% hydrogen by volume.

15. A method of contaminated soil and groundwater remediation comprising:
electrolyzing water in an electrochemical cell;
forming an oxygen water mixture in said electrochemical cell;
forming a hydrogen water mixture in said cell;
extracting a hydrogen water mixture from said electrochemical cell;
separating a portion of hydrogen gas from said hydrogen water mixture; and,
injecting the remaining hydrogen water mixture into a contaminated environment.

16. The method of soil and groundwater remediation of claim 15 further comprising the steps of:
extracting said oxygen water mixture from said electrochemical cell;
injecting said oxygen water mixture into a vessel;
extracting oxygen gas from said vessel;
injecting said oxygen gas into a contaminated environment.

17. The method of soil and groundwater remediation of claim 16 further comprising the step of extracting and compressing said hydrogen gas.

18. The method of soil and groundwater remediation of claim 17 further comprising the step of storing said compressed hydrogen gas in a vessel.

19. The method of soil and groundwater remediation of claim 17 further comprising the step of injecting said hydrogen gas into a contaminated environment.

20. The method of soil and groundwater remediation of claim 17 wherein said hydrogen gas is compressed to a pressure between 200 psi and 10,000 psi.

21. The method of soil and groundwater remediation of claim 20 wherein said hydrogen gas is compressed to a pressure of 2000 psi.

22. The method of soil and groundwater remediation of claim 16 wherein said hydrogen water mixture is injected into said contaminated environment at a pressure between 200 psi and 10,000 psi.

23. The method of soil and groundwater remediation of claim 22 wherein said hydrogen water mixture is 2-10% dissolved hydrogen.

24. The method of soil and groundwater remediation of claim 23 wherein said hydrogen water mixture is between 1-10% dissolved hydrogen.

25. The method of soil and groundwater remediation of claim 24 wherein said hydrogen water mixture is 5% dissolved hydrogen.
